(19) United States
(12) Patent Application Publication
(10) Pub. No.: US 2024/0168559 A1
(43) Pub. Date: May 23, 2024

(54) VIBRATION STRUCTURE, VIBRATION DEVICE, AND TACTILE SENSE PRESENTATION DEVICE

(71) Applicant: Murata Manufacturing Co., Ltd., Nagaokakyo-shi (JP)

(72) Inventor: Junichi HASHIMOTO, Nagaokakyo-shi (JP)

(21) Appl. No.: 18/430,951

(22) Filed: Feb. 2, 2024

Related U.S. Application Data
(63) Continuation of application No. PCT/JP2022/025297, filed on Jun. 24, 2022.

(30) Foreign Application Priority Data
Aug. 6, 2021 (JP) 2021-129417

(51) Int. Cl. G06F 3/01; B06B 1/06; G06F 3/041

(52) U.S. Cl. CPC G06F 3/016; B06B 1/0648; G06F 3/0414

(57) ABSTRACT

A vibration structure that includes: a vibration portion; a piezoelectric member having a first end portion and a second end portion; a frame member that surrounds the vibration portion and the piezoelectric member; a vibration portion support portion that connects the vibration portion and the frame member; a first fixing portion connected to the first end portion; a second fixing portion connected to the second end portion; and first to fourth coupling portions, wherein when a combination of the first coupling portion and the second coupling portion is defined as a first connection member and a combination of the third coupling portion and the fourth coupling portion is defined as a second connection member, each of the first and second connection members includes an elastically deformable portion having a locally increased ease of elastic deformation in a plane direction and a thickness direction.

### CROSS REFERENCE TO RELATED APPLICATIONS

The present application is a continuation of International application No. PCT/JP2022/025297, filed Jun. 24, 2022, which claims priority to Japanese Patent Application No. 2021-129417, filed Aug. 6, 2021, the entire contents of each of which are incorporated herein by reference.

### TECHNICAL FIELD

The present invention relates to a vibration structure, a vibration device, and a tactile sense presentation device.

### BACKGROUND ART

In recent years, there has been proposed a tactile sense presentation device that gives tactile feedback on a touch panel by transmitting vibrations when a user touches the touch panel, making the user feel as if the user pressed the touch panel. For example, Pamphlet of International Publication No. WO2019/013164A1 (Patent Document 1) discloses a tactile sense presentation device including a vibration structure. The vibration structure includes a frame-shaped member having a cavity, a vibration portion disposed in the cavity, and a piezoelectric film. One end of the piezoelectric film is fixed to the frame-shaped member, and the other end is fixed to the vibration portion. When a voltage is applied to the piezoelectric film, the piezoelectric film expands and contracts. A diaphragm is vibrated by expansion and contraction of the piezoelectric film.

On the other hand, there is a case in which a plate-like member of piezoelectric ceramic is used instead of the piezoelectric film. The piezoelectric ceramic is a material that is easily cracked.
Patent Document 1: International Publication No. WO2019/013164A1

### SUMMARY OF THE INVENTION

When a piezoelectric member made of piezoelectric ceramic is adopted, one end of the piezoelectric member is fixed to the frame-shaped member, and the other end is fixed to the vibration portion. In this state, when an impact is applied in the thickness direction of the tactile sense presentation device, one end and the other end of the piezoelectric member are displaced to different positions at different heights in the thickness direction. As a result, the piezoelectric member may be broken.

Therefore, an object of the present invention is to provide a vibration structure, a vibration device, and a tactile sense presentation device, in all of which a piezoelectric member is less likely to be damaged when an impact in a thickness direction is applied.

In order to achieve the above object, a vibration structure according to the present invention includes: a vibration portion; a piezoelectric member having a first end portion and a second end portion respectively at positions opposite to each other, the piezoelectric member being arranged to be spaced apart from the vibration portion in a direction parallel to a surface of the vibration portion; a frame member that surrounds both the vibration portion and the piezoelectric member, the frame member being spaced apart from both of the vibration portion and the piezoelectric member; a vibration portion support portion that connects the vibration portion and the frame member; a first fixing portion connected to the first end portion; a second fixing portion connected to the second end portion; a first coupling portion that connects the first fixing portion and the frame member; a second coupling portion that connects the first fixing portion and the vibration portion; a third coupling portion that connects the second fixing portion and the frame member; and a fourth coupling portion that connects the second fixing portion and the vibration portion, wherein when a combination of the first coupling portion and the second coupling portion is defined as a first connection member and that a combination of the third coupling portion and the fourth coupling portion is a second connection member, each of the first connection member and the second connection member includes an elastically deformable portion having a locally increased ease of elastic deformation in a plane direction and a thickness direction.

According to the present invention, it is possible to realize a vibration structure in which a piezoelectric member is less likely to be damaged when an impact in a thickness direction is applied.

### BRIEF EXPLANATION OF THE DRAWINGS

FIG. 1 is a perspective view of a vibration structure according to a first embodiment of the present invention.

FIG. 2 is a perspective view of a piezoelectric member included in the vibration structure according to the first embodiment of the present invention.

FIG. 3 is an explanatory view showing how a piezoelectric member included in the vibration structure according to the first embodiment of the present invention is deformed.

FIG. 4 is an enlarged plan view of the piezoelectric member and its vicinity in FIG. 1.

FIG. 5 is an enlarged perspective view of a connection portion and its vicinity between the piezoelectric member and a second fixing portion included in the vibration structure according to the first embodiment of the present invention.

FIG. 6 is an explanatory view of the vibration structure according to the first embodiment of the present invention.

FIG. 7 is a first explanatory view showing deformation occurring in the vibration structure according to the first embodiment of the present invention.

FIG. 8 is a second explanatory view showing deformation occurring in the vibration structure according to the first embodiment of the present invention.

FIG. 9 is a conceptual diagram of a vibration device according to the first embodiment of the present invention.

FIG. 10 is a conceptual diagram of a tactile sense presentation device according to the first embodiment of the present invention.

FIG. 11 is an exploded view of the tactile sense presentation device according to the first embodiment of the present invention.

FIG. 12 is an explanatory view showing a state in which an impact is applied to the tactile sense presentation device according to the first embodiment of the present invention.

FIG. 13 is a perspective view of the vibration structure deformed by an impact applied to the tactile sense presentation device according to the first embodiment of the present invention.

FIG. 14 is a sectional view of a back side from a center line of the vibration structure deformed by an impact applied to the tactile sense presentation device according to the first embodiment of the present invention.

FIG. 15 is a perspective view of a vibration structure according to a second embodiment of the present invention.

FIG. 16 is a perspective view of a piezoelectric member included in the vibration structure according to the second embodiment of the present invention.

FIG. 17 is a perspective view of a portion after the piezoelectric member is removed from the vibration structure according to the second embodiment of the present invention.

FIG. 18 is an enlarged perspective view of a second connection member and its vicinity in FIG. 17.

FIG. 19 is an enlarged explanatory view showing a first coupling portion and its vicinity of the vibration structure according to the second embodiment of the present invention.

FIG. 20 is a first explanatory view showing deformation occurring in the vibration structure according to the second embodiment of the present invention.

FIG. 21 is a second explanatory view showing deformation occurring in the vibration structure according to the second embodiment of the present invention.

FIG. 22 is a conceptual diagram of a tactile sense presentation device according to the second embodiment of the present invention.

FIG. 23 is an exploded view of the tactile sense presentation device according to the second embodiment of the present invention.

FIG. 24 is a perspective view of the vibration structure deformed by an impact applied to the tactile sense presentation device according to the second embodiment of the present invention.

FIG. 25 is a sectional view of a back side from a center line of the vibration structure deformed by an impact applied to the tactile sense presentation device according to the second embodiment of the present invention.

FIG. 26 is a graph showing displacement of a vibration portion obtained when a signal of a first resonance frequency is transmitted from a driving portion in the vibration device according to the second embodiment of the present invention.

FIG. 27 is a graph showing displacement of a vibration portion obtained when a signal of a second resonance frequency is transmitted from the driving portion in the vibration device according to the second embodiment of the present invention.

FIG. 28 is a graph showing displacement of a vibration portion obtained when a combined signal is transmitted from the driving portion in the vibration device according to the second embodiment of the present invention.

FIG. 29 is a conceptual diagram of a vibration device according to a third embodiment of the present invention.

FIG. 30 is a perspective view of a piezoelectric member included in the vibration structure according to the third embodiment of the present invention.

FIG. 31 is a sectional view taken along line XXXI-XXXI in FIG. 29 as viewed in a direction of arrows.

FIG. 32 is a sectional view taken through the first coupling portion, a first fixing portion, and a second coupling portion in FIG. 29.

FIG. 33 is a sectional view taken through a third coupling portion, a second fixing portion, and a fourth coupling portion in FIG. 29.

FIG. 34 is a perspective view of only a first plate member included in the vibration structure according to the third embodiment of the present invention taken out.

FIG. 35 is a perspective view of only a second plate member included in the vibration structure according to the third embodiment of the present invention taken out.

FIG. 36 is a perspective view showing the piezoelectric member is placed on the second plate member included in the vibration structure according to the third embodiment of the present invention.

FIG. 37 is a perspective view of a spacer included in the vibration structure according to the third embodiment of the present invention.

FIG. 38 is a first explanatory view showing deformation occurring in the vibration structure according to the third embodiment of the present invention.

FIG. 39 is a second explanatory view showing deformation occurring in the vibration structure according to the third embodiment of the present invention.

FIG. 40 is a perspective view of the vibration structure deformed by an impact applied to the tactile sense presentation device according to the third embodiment of the present invention.

FIG. 41 is a sectional view of a back side from a center line of the vibration structure deformed by an impact applied to the tactile sense presentation device according to the third embodiment of the present invention.

### DETAILED DESCRIPTION OF THE INVENTION

Dimensional ratios shown in the drawings do not always precisely represent the actual dimensional ratios, and may be exaggerated for convenience of explanation. In the following description, when the concept of up or down is referred to, the concept does not always mean absolute up or down but relative up or down in the illustrated posture in some cases.

### First Embodiment

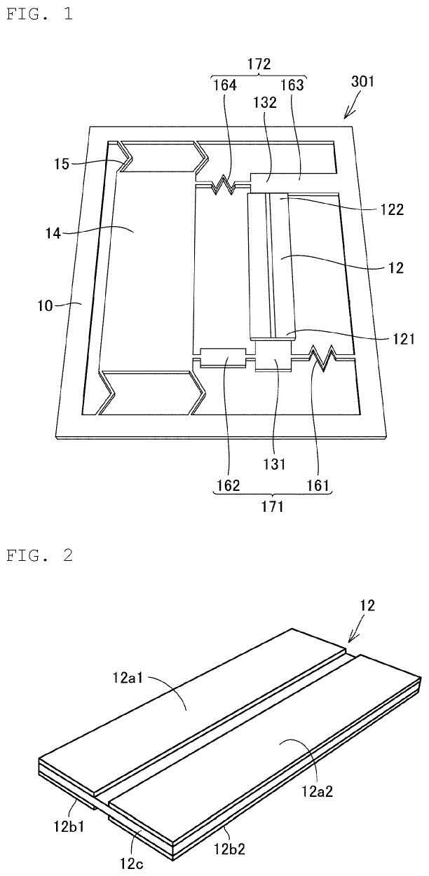

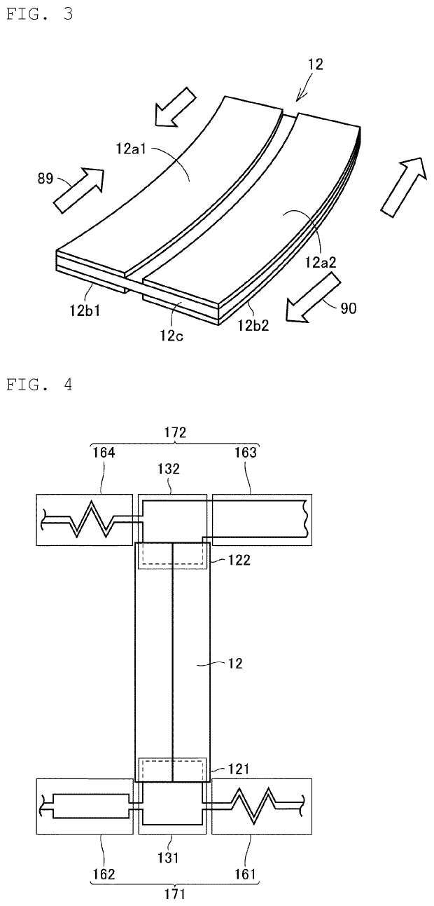

A vibration structure according to a first embodiment based on the present invention will be described with reference to FIGS. 1 to 6. FIG. 1 illustrates a vibration structure 301 according to the present embodiment. The vibration structure 301 includes a plate-like vibration portion 14 and a piezoelectric member 12. The piezoelectric member 12 includes a first end portion 121 and a second end portion 122 respectively at positions opposite to each other. The piezoelectric member 12 is arranged to be spaced apart from the vibration portion 14 in a direction parallel to a surface of the vibration portion 14. The piezoelectric member 12 is plate-like. A longitudinal direction of the piezoelectric member 12 and a longitudinal direction of the vibration portion 14 are parallel to each other. FIG. 2 illustrates the piezoelectric member 12 taken out alone. The piezoelectric member 12 includes conductive thin layers 12a1, 12a2, 12b1, and 12b2 and a piezoelectric material layer 12c. The conductive thin layers 12a1 and 12a2 are disposed on one surface of the piezoelectric material layer 12c, and the conductive thin layers 12b1 and 12b2 are disposed on the other surface. A first portion of the piezoelectric material layer 12c is sandwiched between the conductive thin layer 12a1 and the conductive thin layer 12b1. A second portion of the piezoelectric material layer 12c is sandwiched between the conductive thin layer 12a2 and the conductive thin layer 12b2. When a certain voltage is applied between the conductive thin layer 12a1 and the conductive thin layer 12b1 and a voltage opposite to the certain voltage is applied between the conductive thin layer 12a2 and the conductive thin layer 12b2, the piezoelectric member 12 deforms as shown in FIG. 3. That is, the first portion contracts as indicated by an arrow 89, and the second portion expands as indicated by an arrow 90. When the voltage is reversed, deformation occurs in an opposite direction. Therefore, applying a sine wave voltage to the first portion and a sine wave voltage having a phase opposite to a phase of the sine wave voltage to the second portion causes the piezoelectric member 12 to be deformed repeatedly so as to swing left and right in an in-plane direction. In a case where not only the sine wave voltage but also a voltage in which a positive side and a negative side are alternately changed is applied, the piezoelectric member 12 is repeatedly deformed so as to be bent to left and right in the in-plane direction.

As illustrated in FIG. 1, the vibration structure 301 includes a frame member 10. The frame member 10 collectively surrounds the vibration portion 14 and the piezoelectric member 12 separately from both the vibration portion 14 and the piezoelectric member 12. The vibration structure 301 includes a vibration portion support portion 15 that connects the vibration portion 14 and the frame member 10. In the example shown here, four vibration portion support portions 15 are provided. Each of the vibration portion support portions 15 is sufficiently thin as compared with other portions and is easily elastically deformed. Each of the vibration portion support portions 15 is in a V shape in plan view. The vibration portion 14 is rectangular in plan view. The two vibration portion support portions 15 are connected to one short side of the vibration portion 14, and the other two vibration portion support portions 15 are connected to the other short side. The vibration portion support portions 15 are respectively disposed at both ends of both short sides of the vibration portion 14.

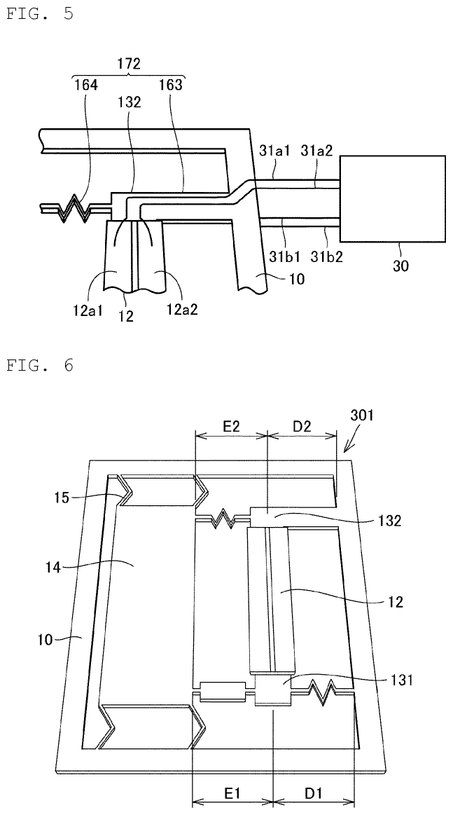

As illustrated in FIG. 1, the vibration structure 301 includes a first fixing portion 131 and a second fixing portion 132. The first fixing portion 131 is connected to the first end portion 121. The second fixing portion 132 is connected to the second end portion 122. The vibration structure 301 includes a first coupling portion 161, a second coupling portion 162, a third coupling portion 163, and a fourth coupling portion 164. The first coupling portion 161 connects the first fixing portion 131 and the frame member 10. The second coupling portion 162 connects the first fixing portion 131 and the vibration portion 14. The third coupling portion 163 connects the second fixing portion 132 and the frame member 10. The fourth coupling portion 164 connects the second fixing portion 132 and the vibration portion 14. FIG. 4 shows an enlarged plan view of the piezoelectric member 12 and its vicinity in FIG. 1. The first coupling portion 161 includes a straight portion and a bent portion. The bent portion has a zigzag shape. The bent portion is disposed in the middle of the first coupling portion 161. The fourth coupling portion 164 has the same structure as the first coupling portion 161. A middle of the second coupling portion 162 constitutes a substantially rectangular portion having a constant width, and each side of the rectangular portion in front of and behind the second coupling portion 162 constitutes a thinner line shape having a constant width. The third coupling portion 163 is a linear portion having a large constant width.

A combination of the first coupling portion 161 and the second coupling portion 162 is defined as a first connection member 171. A combination of the third coupling portion 163 and the fourth coupling portion 164 is defined as a second connection member 172. Each of the first connection member 171 and the second connection member 172 includes an elastically deformable portion having locally increased ease of elastic deformation in a plane direction and a thickness direction. In the example illustrated in FIG. 1, the elastically deformable portion included in the first connection member 171 is the bent portion provided in the middle of the first coupling portion 161. The elastically deformable portion included in the second connection member 172 is the bent portion provided in the middle of the fourth coupling portion 164.

FIG. 5 is an enlarged view of a connection portion and its vicinity between the piezoelectric member 12 and the second fixing portion 132. In this drawing, a driving portion 30 not shown in FIG. 1 is also illustrated. Wirings 31a1, 31a2, 31b1, and 31b2 extend from the driving portion 30. The wirings 31a1 and 31a2 are respectively connected to the conductive thin layers 12a1 and 12a2. The wirings 31b1 and 31b2 are respectively connected to conductive thin layers 12b1 and 12b2 (not shown in FIG. 5). Insulating coating is applied to the wirings except for the connection portion so as not to cause an unnecessary short circuit. The wirings illustrated here are merely examples, and other structures may be adopted as long as a voltage can be applied to the piezoelectric member 12 from the outside.

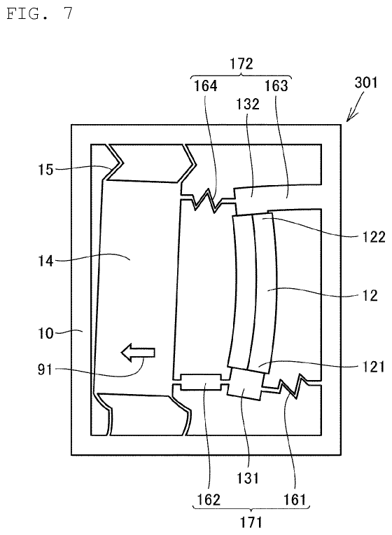

More preferably, in the vibration structure 301, as illustrated in FIG. 6, a distance D1 from the first fixing portion 131 to the frame member 10 is equal to a distance D2 from the second fixing portion 132 to the frame member 10. Further, a distance E1 from the first fixing portion 131 to the vibration portion 14 is equal to a distance E2 from the second fixing portion 132 to the vibration portion 14. As used herein, the term “equal” includes a substantially equal state. Since the first fixing portion 131 has a certain width, the distance from the first fixing portion 131 corresponds to a distance from a center of the first fixing portion 131. That is, the distance is a distance from a center line of the piezoelectric member 12. The same concept applies to the distance from the second fixing portion 132. The distance D1 and the distance E1 may be different. The distance D2 and the distance E2 may be different.

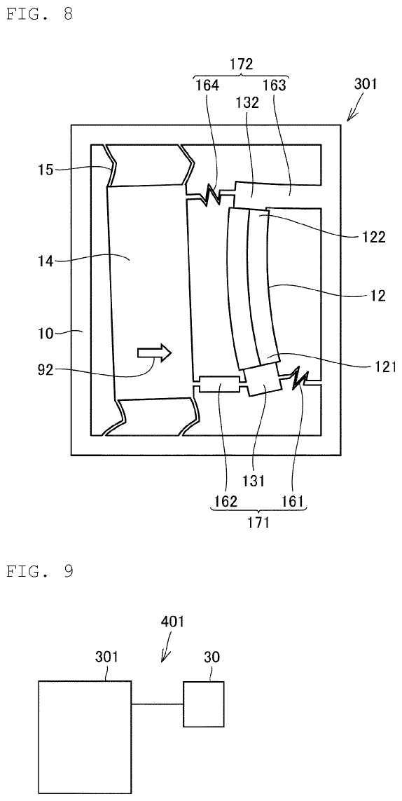

When a voltage that alternately switches between positive and negative is applied to the piezoelectric member 12, the vibration structure 301 is repeatedly deformed such that the state illustrated in FIG. 7 and the state illustrated in FIG. 8 alternately appear. In the state illustrated in FIG. 7, since the first end portion 121 of the piezoelectric member 12 is displaced toward left in the drawing, a force indicated by an arrow 91 acts on the vibration portion 14, and the vibration portion 14 is displaced toward the left in the drawing while slightly rotating in a clockwise direction. In the state illustrated in FIG. 8, since the first end portion 121 of the piezoelectric member 12 is displaced toward right in the drawing, a force indicated by an arrow 92 acts on the vibration portion 14, and the vibration portion 14 is displaced toward the right in the drawing while slightly rotating in a counterclockwise direction.

With reference to FIG. 9, a vibration device 401 according to the present embodiment will be described. The vibration device 401 includes the vibration structure 301 and the driving portion 30. Details of the vibration structure 301 are as described above. The vibration structure 301 and the driving portion 30 are electrically connected by wiring.

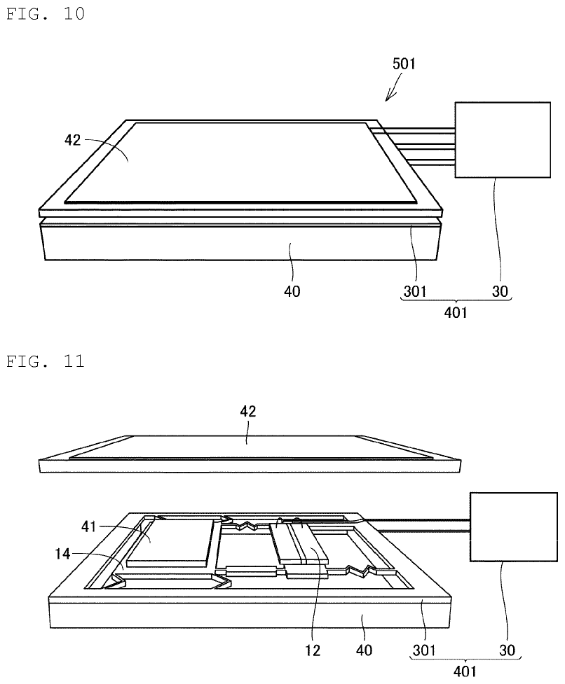

With reference to FIGS. 10 to 11, a tactile sense presentation device 501 according to the present embodiment will be described. As illustrated in FIG. 10, the tactile sense presentation device 501 includes a casing 40, the vibration device 401, and an operation plate 42. The vibration structure 301 of the vibration device 401 is placed on the casing 40. The operation plate 42 is disposed above the vibration structure 301. The operation plate 42 is arranged to be spaced apart from the vibration structure 301.

FIG. 11 illustrates the tactile sense presentation device 501 in an exploded state. FIG. 11 illustrates a state in which the operation plate 42 is removed. The casing 40 is a frame-shaped member, and the frame member 10 of the vibration structure 301 and the casing 40 have substantially the same shape in plan view. A spacer 41 is placed on an upper side of the vibration portion 14 of the vibration structure 301. The operation plate 42 is disposed so as to be placed on an upper surface of the spacer 41. A thickness of the spacer 41 is larger than a thickness of the piezoelectric member 12. Therefore, when the operation plate 42 is placed on the upper surface of the spacer 41, the operation plate 42 is not in contact with the piezoelectric member 12. The operation plate 42 is not in contact with the frame member 10. An external switch may be arranged on an upper surface of the operation plate 42. The external switch is connected to the driving portion 30 via wirings. When a user touches the external switch to turn on the external switch, the driving portion 30 applies a voltage alternately switching between positive and negative to the piezoelectric member 12. With this, the piezoelectric member 12 is repeatedly deformed. As a result, the vibration portion 14 vibrates. The vibration of the vibration portion 14 is transmitted to the operation plate 42 through the spacer 41. As a result, the vibration is transmitted to the user in contact with the operation plate 42. In this way, the function as the tactile sense presentation device 501 can be exhibited.

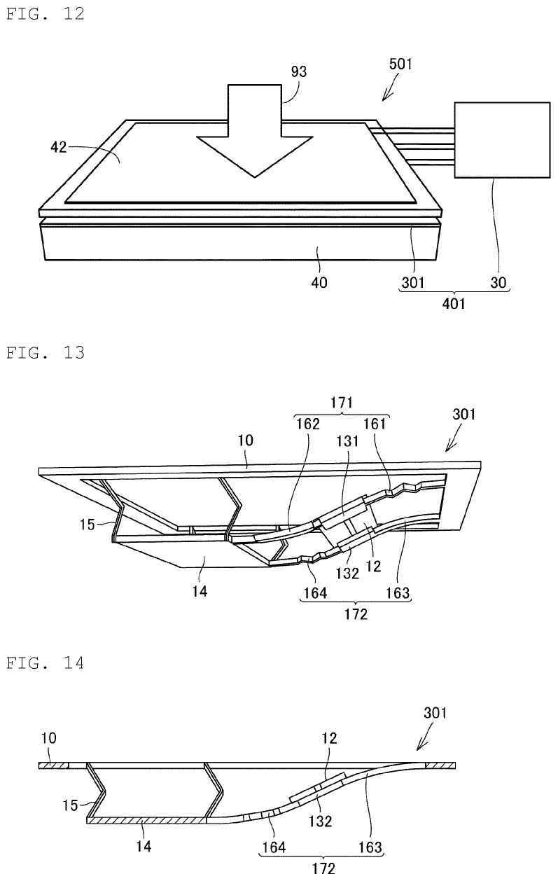

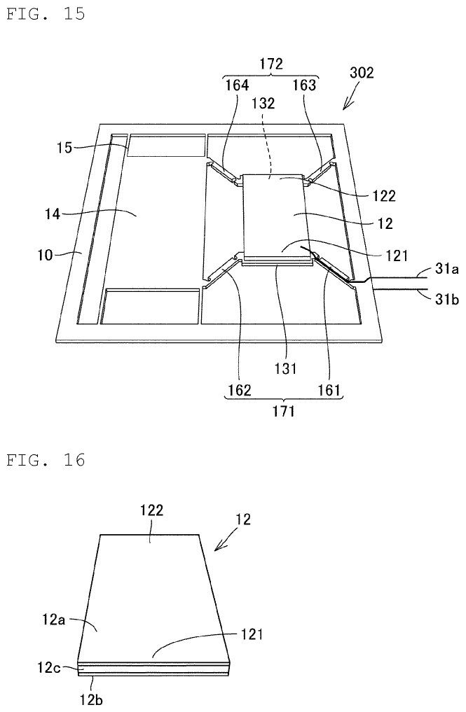

As illustrated in FIG. 12, when an impact is applied to the operation plate 42 of the tactile sense presentation device 501 in the direction of an arrow 93, the vibration structure 301 included in the tactile sense presentation device 501 deforms as illustrated in FIG. 13. In FIG. 13, only the vibration structure 301 is illustrated. The vibration portion 14 and the piezoelectric member 12 are displaced downward. FIG. 14 is a sectional view of a back side from a center line of the vibration structure 301 in this state. In a case where a length of the first coupling portion 161 and a length of the third coupling portion 163 are substantially the same, and a length of the second coupling portion 162 and a length of the fourth coupling portion 164 are substantially the same, if the vibration portion 14 is largely displaced downward, a front end and a back end of the piezoelectric member 12 are only displaced downward by the same degree, as illustrated in FIG. 13, and therefore a large load is not applied to an intermediate portion of the piezoelectric member 12, and as a result, it is possible to prevent the piezoelectric member 12 from being broken.

In the present embodiment, as described above, it is possible to realize the vibration structure, the vibration device, and the tactile sense presentation device, in all of which a piezoelectric member is less likely to be damaged when an impact in a thickness direction is applied.

As a material of the piezoelectric member 12, for example, lead-free piezoelectric ceramic such as niobium-based piezoelectric ceramic can be used. Further, as the piezoelectric member 12, a piezoelectric film such as polyvinylidene fluoride, a piezoelectric fiber such as polystyrene, or an electrostrictive polymer can also be used. A shape memory alloy or the like can also be used as the piezoelectric member 12 in a pseudo manner. In particular, it is preferable to use a piezoelectric ceramic material exhibiting a large inverse piezoelectric effect such as lead zirconate titanate. In this case, the vibration of the vibration portion can be increased. The piezoelectric member 12 is not limited to a member made only of a piezoelectric material, and may be a composite member containing an ion conductive material. Further, the piezoelectric member 12 itself may be a member having ion conductivity. For example, when there is a material having piezoelectricity and ion conductivity, the piezoelectric member 12 may be made of such a material.

As a material of the vibration portion 14, it is possible to use, for example, a fiber-reinforced plastic material such as an acrylic resin, polyethylene terephthalate, polycarbonate, or a glass epoxy composite material, metal, glass, or the like. When a metal is used as the material of the vibration portion 14, a stainless steel, a tungsten alloy, a titanium alloy, or the like is preferably used. In order to realize the vibration portion 14, a substrate material for circuit wiring may be used. In this case, components for electrical wiring can be simplified.

### Second Embodiment

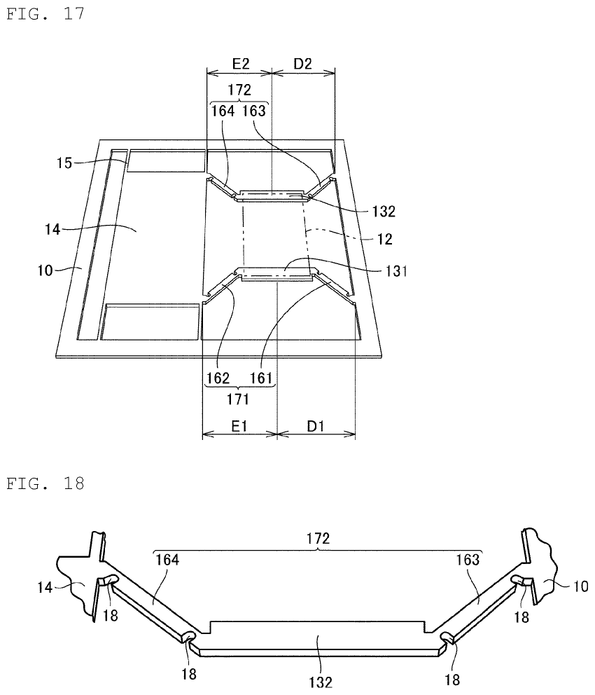

A vibration structure according to a second embodiment based on the present invention will be described with reference to FIGS. 15 to 19. FIG. 15 illustrates a vibration structure 302 according to the present embodiment. A basic configuration of the vibration structure 302 is similar to that described in the first embodiment. In the present embodiment, each of the vibration portion support portions 15 is linear. FIG. 16 illustrates the piezoelectric member 12 taken out alone. The piezoelectric member 12 includes conductive thin layers 12a and 12b and a piezoelectric material layer 12c. The piezoelectric material layer 12c is sandwiched between the conductive thin layer 12a and the conductive thin layer 12b. When a certain voltage is applied between the conductive thin layer 12a and the conductive thin layer 12b, the piezoelectric member 12 expands in a long side direction. In addition, when a voltage of an opposite sign is applied, the piezoelectric member 12 contracts in the long side direction.

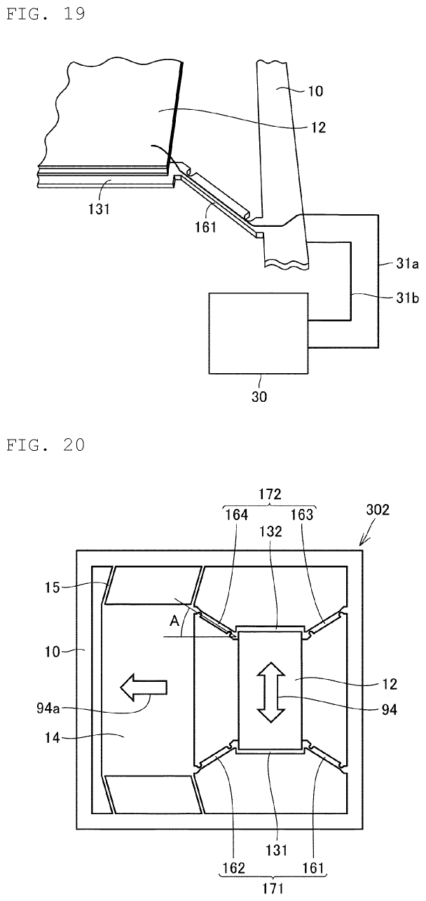

FIG. 17 illustrates a portion after the piezoelectric member 12 is removed from the vibration structure 302. FIG. 18 is an enlarged view of the second connection member 172 and its vicinity in FIG. 17. The second connection member 172 includes the third coupling portion 163 and the fourth coupling portion 164. The third coupling portion 163 connects the second fixing portion 132 and the frame member 10. The fourth coupling portion 164 connects the second fixing portion 132 and the vibration portion 14. The second connection member 172 has a constricted portion 18.

Each of the first connection member 171 and the second connection member 172 includes an elastically deformable portion having locally increased ease of elastic deformation in a plane direction and a thickness direction. The elastically deformable portion includes the constricted portion 18 at which a sectional area is locally small.

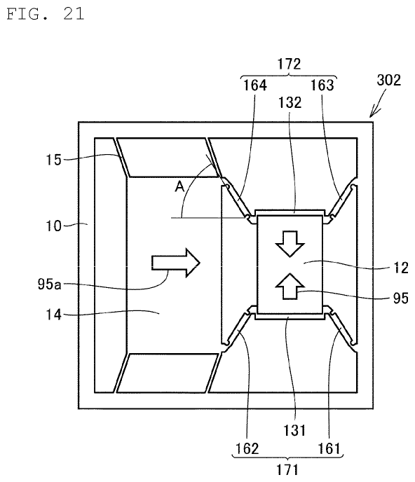

FIG. 19 is an enlarged view of the first coupling portion 161 and its vicinity. In this drawing, the driving portion 30 not shown in FIG. 15 is also illustrated. Wirings 31a and 31b extend from the driving portion 30. The wirings 31a and 31b are connected to the piezoelectric member 12 via the first coupling portion 161. The wiring 31a is connected to the conductive thin layer 12a, and the wiring 31b is connected to the conductive thin layer 12b.

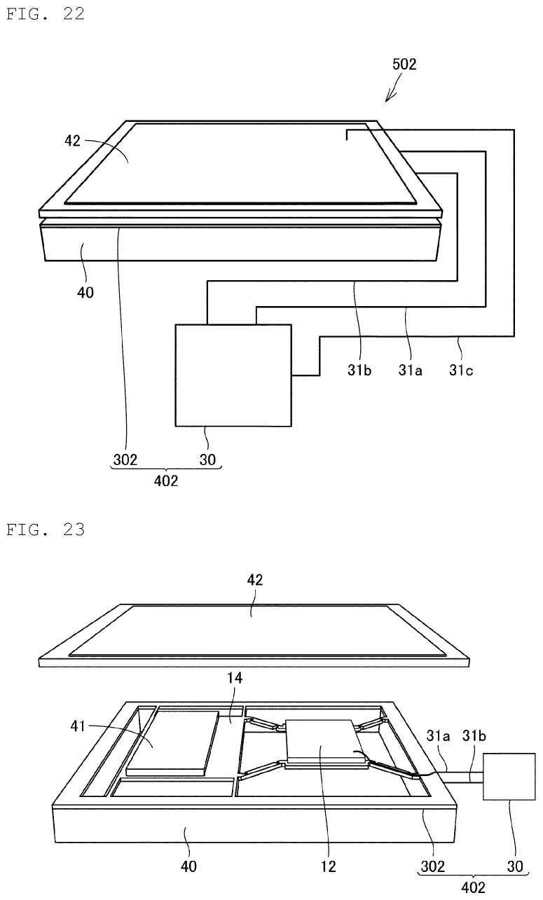

When a voltage that alternately switches between positive and negative is applied to the piezoelectric member 12, the vibration structure 302 is repeatedly deformed such that the state illustrated in FIG. 20 and the state illustrated in FIG. 21 alternately appear. In the state illustrated in FIG. 20, since the piezoelectric member 12 expands as indicated by an arrow 94, an angle A decreases, and the vibration portion 14 is pushed in a direction of an arrow 94a. Since the vibration portion support portion 15 is sufficiently thin, it allows displacement of the vibration portion 14 in the direction of the arrow 94a. In the state illustrated in FIG. 21, since the piezoelectric member 12 contracts as indicated by an arrow 95, the angle A increases and the vibration portion 14 is attracted in a direction of an arrow 95a. When the state illustrated in FIG. 20 and the state illustrated in FIG. 21 alternately appear, the vibration portion 14 alternately repeats the displacement represented by the arrow 94a and the displacement represented by the arrow 95a, and consequently vibrates.

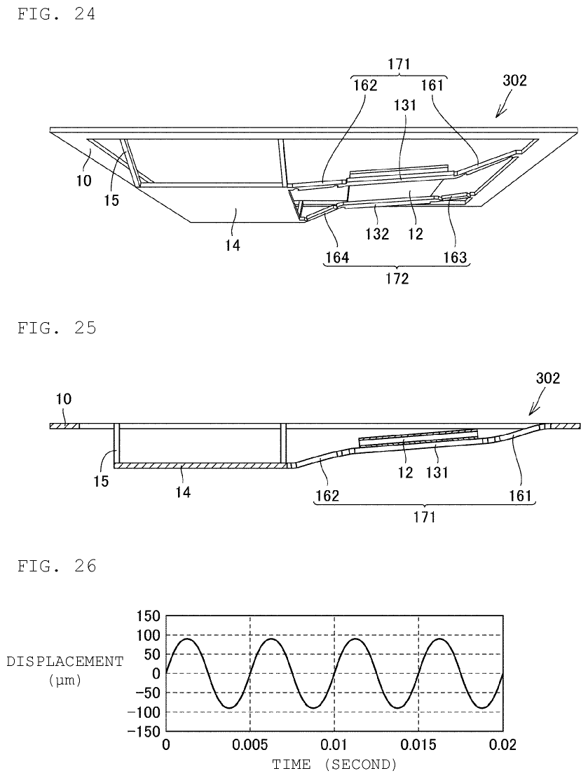

With reference to FIGS. 22 to 23, a tactile sense presentation device 502 according to the present embodiment will be described. As illustrated in FIG. 22, the tactile sense presentation device 502 includes the casing 40, a vibration device 402, and the operation plate 42. The vibration structure 302 of the vibration device 402 is placed on the casing 40. The operation plate 42 is disposed above the vibration structure 302. The operation plate 42 is arranged to be spaced apart from the vibration structure 302.

FIG. 23 illustrates the tactile sense presentation device 502 in an exploded state. FIG. 23 illustrates a state in which the operation plate 42 is removed. The casing 40 is a frame-shaped member, and the frame member 10 of the vibration structure 302 and the casing 40 have substantially the same shape in plan view. The spacer 41 is placed on an upper side of the vibration portion 14 of the vibration structure 302. Other configurations are similar to those described for the tactile sense presentation device 501 in the first embodiment, and thus, description thereof will not be repeated.

When an impact is applied to the tactile sense presentation device 502, the vibration structure 302 included in the tactile sense presentation device 502 deforms as illustrated in FIG. 24. In FIG. 24, only the vibration structure 302 is illustrated. The vibration portion 14 and the piezoelectric member 12 are displaced downward. FIG. 25 is a sectional view of a back side from a center line of the vibration structure 302 in this state. Other circumstances are similar to those described for the tactile sense presentation device 501 in the first embodiment, and thus, description thereof will not be repeated.

Also in the present embodiment, similarly to the first embodiment, it is possible to provide the vibration structure, the vibration device, and the tactile sense presentation device, in all of which a piezoelectric member is less likely to be damaged when an impact in a thickness direction is applied.

The rectangular thin plate-like piezoelectric member 12 according to the present embodiment has a resonance frequency in a long-side spreading mode and a resonance frequency in a short-side spreading mode. The vibration structure 302 on which the piezoelectric member 12 is mounted has a first resonance frequency determined due to the long-side spreading mode of the piezoelectric member 12 and a second resonance frequency determined due to the short-side spreading mode of the piezoelectric member 12. Dimensions of the long side and the short side of the piezoelectric member 12 can be set such that, for example, the second resonance frequency is twice the first resonance frequency.

The resonance mode to be set may be resonance other than the long side direction and the short side direction as long as the resonance mode is the spreading mode in a direction of a main surface of the piezoelectric member 12, and dimensions to be adjusted to control the resonance is not limited to either the long side or the short side of the piezoelectric member 12. The desired resonance frequency may be achieved by adjusting the dimensions of the other portions.

The vibration device 402 is a vibration device including the vibration structure 302 and the driving portion 30 that drives the vibration structure 302 with an AC voltage including two or more frequency components, wherein the vibration structure 302 preferably has two or more resonance bands caused by a resonance mode in a direction parallel to a surface of the piezoelectric member 12, and each of the two or more resonance bands preferably includes any one of the two or more frequency components.

For example, in a case where the dimensions of the long side and the short side of the piezoelectric member 12 are set such that the second resonance frequency is twice the first resonance frequency, the effect described in the first embodiment can be obtained, and in addition, resonance vibration having different speeds in the forward path and the backward path can be caused. This effect will be described with reference to FIGS. 26 to 28. In each of FIGS. 26 to 28, a horizontal axis represents time, and a vertical axis represents displacement of the vibration portion 14. The displacement on the side where the vibration portion 14 approaches the piezoelectric member 12 is taken as positive.

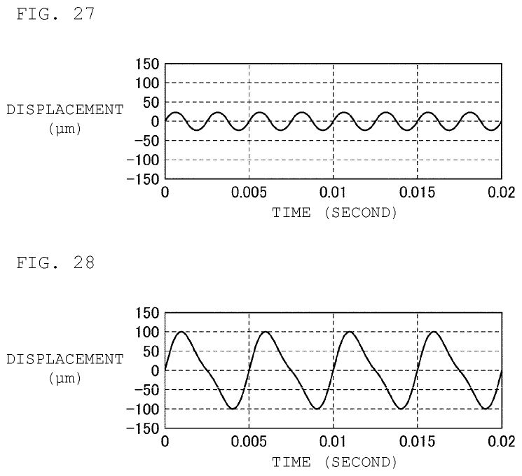

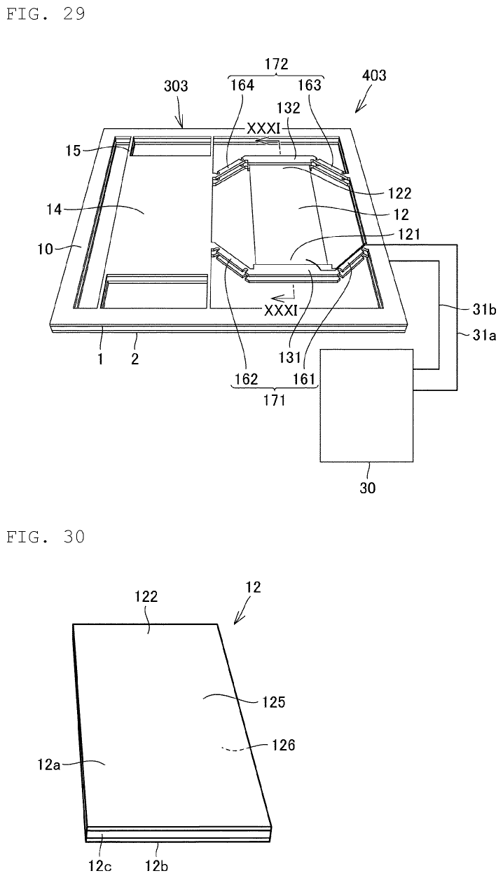

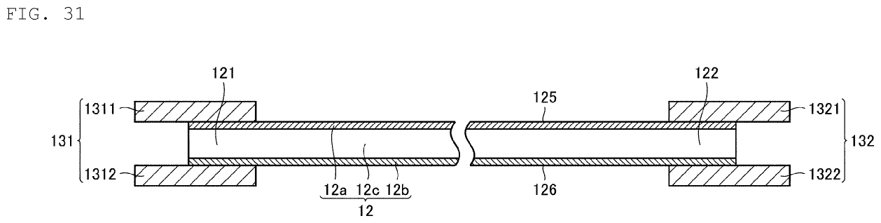

FIG. 26 illustrates a state of displacement of the vibration portion 14 obtained when a signal of a first resonance frequency (hereinafter, the signal is referred to as “first signal”) is transmitted from the driving portion 30. FIG. 27 illustrates a state of displacement of the vibration portion 14 obtained when a signal of a second resonance frequency whose amplitude is 25% of the first signal (hereinafter, the signal is referred to as “second signal”) is transmitted from the driving portion 30. In a case where the vibration device 402 is driven by transmitting a signal (hereinafter, it is referred to as a “third signal”) obtained by combining the first signal and the second signal from the driving portion 30, an obtained state of the displacement of the vibration portion 14 is as illustrated in FIG. 28. That is, the vibration portion 14 vibrates in a sawtooth shape.

In FIG. 28, a curve representing change in displacement of the vibration portion 14 has different slopes when increasing and when decreasing. This means that the speed is different between a forward path and a return path of the vibration. The third signal as the drive signal includes two components of the first signal and the second signal, and each of the first signal and the second signal has a resonance frequency at which a vibration amplitude is maximized, and therefore, it is possible to obtain very large sawtooth wave vibration as compared with a case where driving is performed using a combined signal in a case where either of the components is in a non-resonance band.

The tactile sense presentation device 502 according to the present embodiment includes the vibration device 402 described above, and the operation plate 42 connected to the vibration portion 14 so as not to contact with the piezoelectric member 12 and the frame member 10. By adopting this configuration, it is possible to achieve a tactile sense presentation device in which the piezoelectric member is less likely to be damaged when an impact in the thickness direction is applied.

In the tactile sense presentation device 502 illustrated in FIG. 22, when the third signal is continuously driven as illustrated in FIG. 28 to drop the liquid droplet on the upper surface of the operation plate 42, the liquid droplet moves to a higher speed in the forward path and the backward path of the vibration. Utilizing this phenomenon, the tactile sense presentation device 502 can be used as a transport device or a removal device for raindrops, dust, and the like. Here, one example in which the sawtooth wave is generated has been described, but the vibration to be obtained is not limited to the sawtooth wave as long as the vibration has different speeds in the forward path and the backward path. The number, amplitude ratio, and phase shift of the drive signals synthesized to obtain the drive signal are not limited to those described herein.

### Third Embodiment

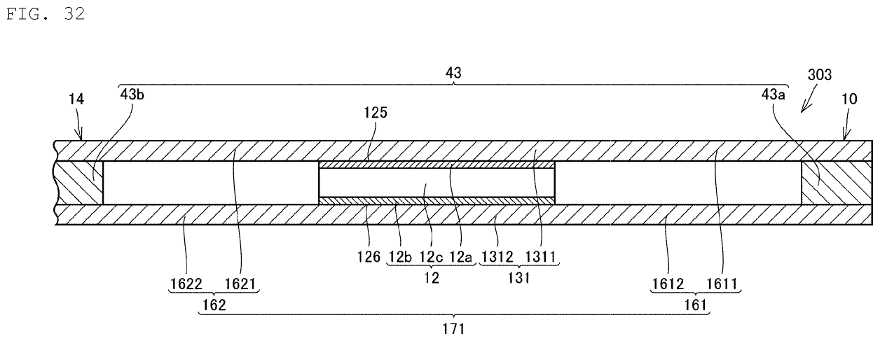

A vibration device according to a third embodiment based on the present invention will be described with reference to FIGS. 29 to 37. FIG. 29 illustrates a vibration device 403 according to the present embodiment. The vibration device 403 includes a vibration structure 303 and the driving portion 30. The vibration structure 303 includes a first plate member 1 and a second plate member 2. Details of the first plate member 1 and the second plate member 2 will be described later. A basic configuration of the vibration structure 303 is similar to that described in the first embodiment. FIG. 30 illustrates the piezoelectric member 12 taken out alone. The structure of the piezoelectric member 12 is similar to that described in the second embodiment. The piezoelectric member 12 has a first surface 125 and a second surface 126. A sectional view taken along line XXXI-XXXI in FIG. 29 is illustrated in FIG. 31.

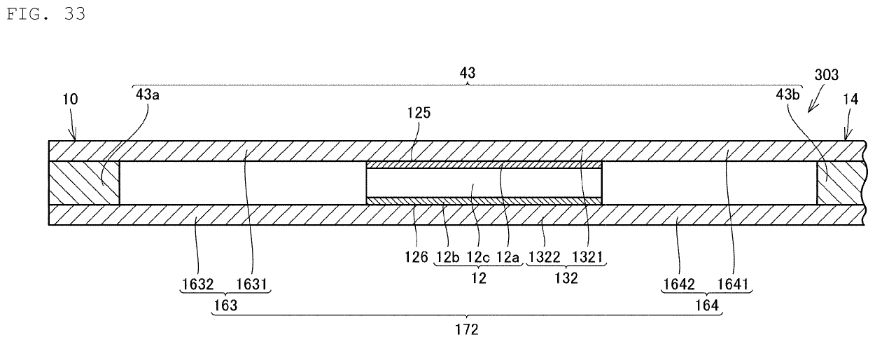

FIG. 32 is a sectional view taken through the first coupling portion 161, the first fixing portion 131, and the second coupling portion 162 in FIG. 29. These are not originally on a straight line, but for convenience of description, these continuous in a polygonal line shape are shown as one sectional view in FIG. 32. Similarly, FIG. 33 is a sectional view taken through the third coupling portion 163, the second fixing portion 132, and the fourth coupling portion 164 in FIG. 29.

In the vibration structure 303 according to the present embodiment, the piezoelectric member 12 has the first surface 125 and the second surface 126 which are opposite surfaces to each other. The first fixing portion 131 includes a first-surface first fixing portion 1311 connected to the first surface 125 and a second-surface first fixing portion 1312 connected to the second surface 126. The second fixing portion 132 includes a first-surface second fixing portion 1321 connected to the first surface 125 and a second-surface second fixing portion 1322 connected to the second surface 126. The first coupling portion 161 includes a first-surface first coupling portion 1611 that connects the first-surface first fixing portion 1311 and the frame member 10, and a second-surface first coupling portion 1612 that connects the second-surface first fixing portion 1312 and the frame member 10. The second coupling portion 162 includes a first-surface second coupling portion 1621 that connects the first-surface first fixing portion 1311 and the vibration portion 14, and a second-surface second coupling portion 1622 that connects the second-surface first fixing portion 1312 and the vibration portion 14. The third coupling portion 163 includes a first-surface third coupling portion 1631 that connects the first-surface second fixing portion 1321 and the frame member 10, and a second-surface third coupling portion 1632 that connects the second-surface second fixing portion 1322 and the frame member 10. The fourth coupling portion 164 includes a first-surface fourth coupling portion 1641 that connects the first-surface second fixing portion 1321 and the vibration portion 14, and a second-surface fourth coupling portion 1642 that connects the second-surface second fixing portion 1322 and the vibration portion 14.

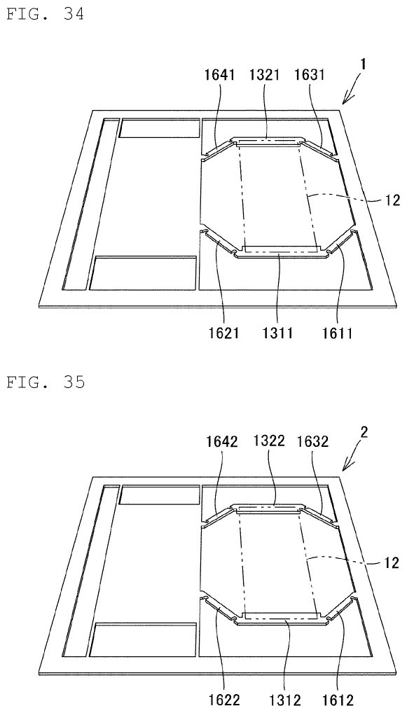

FIG. 34 illustrates a state where only the first plate member 1 included in the vibration structure 303 illustrated in FIG. 29 is taken out. The first plate member 1 includes the first-surface first coupling portion 1611, the first-surface first fixing portion 1311, the first-surface second coupling portion 1621, the first-surface third coupling portion 1631, the first-surface second fixing portion 1321, and the first-surface fourth coupling portion 1641.

FIG. 35 illustrates a state where only the second plate member 2 included in the vibration structure 303 illustrated in FIG. 29 is taken out. The second plate member 2 includes the second-surface first coupling portion 1612, the second-surface first fixing portion 1312, the second-surface second coupling portion 1622, the second-surface third coupling portion 1632, the second-surface second fixing portion 1322, and the second-surface fourth coupling portion 1642.

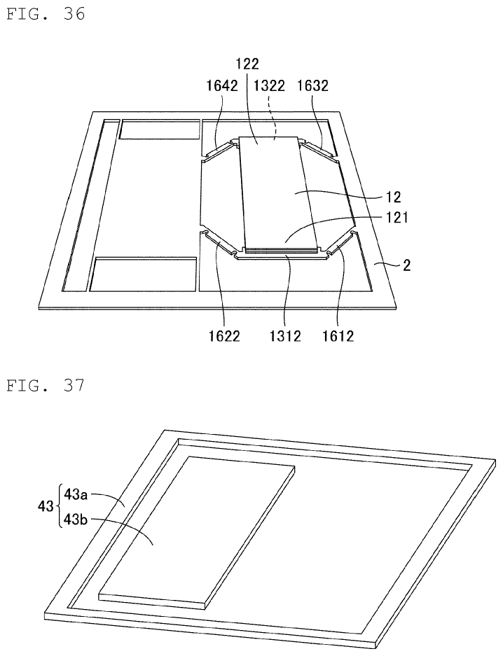

FIG. 36 illustrates a state in which the piezoelectric member 12 is placed on the second plate member 2. The first end portion 121 of the piezoelectric member 12 is fixed in a state of being placed on the second-surface first fixing portion 1312. The second end portion 122 of the piezoelectric member 12 is fixed in a state of being placed on the second-surface second fixing portion 1322.

Furthermore, a spacer 43 as illustrated in FIG. 37 is prepared. The spacer 43 includes a frame member spacer 43a and a vibration portion spacer 43b. The spacer 43 is stacked on a structure illustrated in FIG. 36. The frame member spacer 43a is placed on a frame-shaped portion provided on an outer edge portion of the second plate member 2. The vibration portion spacer 43b is placed on a plate-like portion constituting a part of the vibration portion 14 in the second plate member 2. Further, by placing and fixing the first plate member 1 on an upper side of this structure, the vibration structure 303 illustrated in FIG. 29 is obtained. Moreover, the vibration device 403 is obtained by connecting the driving portion 30 to the vibration structure 303 via the wirings 31a and 31b.

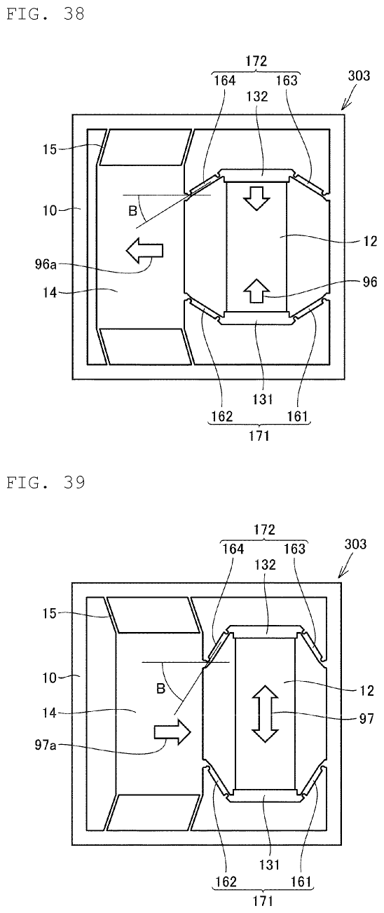

When a voltage that alternately switches between positive and negative is applied to the piezoelectric member 12, the vibration structure 303 is repeatedly deformed such that the state illustrated in FIG. 38 and the state illustrated in FIG. 39 alternately appear. In the state illustrated in FIG. 38, the piezoelectric member 12 is deformed so as to contract in the longitudinal direction as indicated by an arrow 96. At this time, since an angle B decreases, the vibration portion 14 moves to the left in the drawing and approaches the frame member 10. In the state illustrated in FIG. 39, the piezoelectric member 12 is deformed so as to expand in the longitudinal direction as indicated by an arrow 97. At this time, since the angle B increases, the vibration portion 14 moves to the right in the drawing and moves away from the frame member 10. Since the state illustrated in FIG. 38 and the state illustrated in FIG. 39 appear alternately, the vibration portion 14 vibrates in a direction perpendicular to the longitudinal direction as a result.

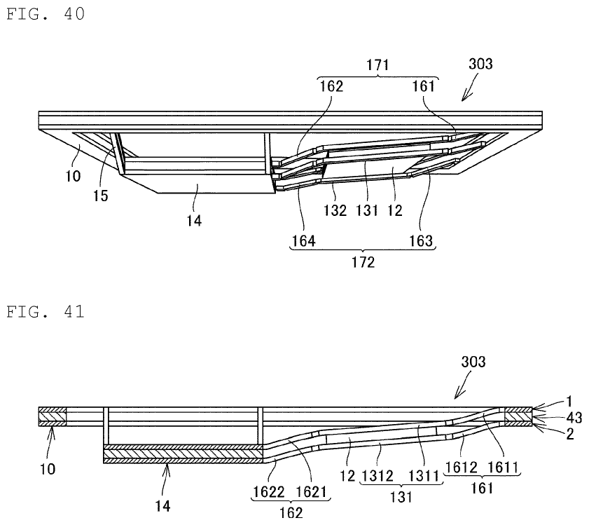

When an impact is applied, the vibration structure 303 is deformed as illustrated in FIG. 40. In FIG. 40, only the vibration structure 303 is illustrated. The vibration portion 14 and the piezoelectric member 12 are displaced downward. FIG. 41 is a sectional view of a back side from a center line of the vibration structure 303 in this state. Since the configuration of the other portions is similar to that described in the first and the second embodiment, the description will not be repeated.

In the present embodiment, both an upper surface and a lower surface of the piezoelectric member 12 are fixed by the fixing portion, but for example, in a case where only the lower surface side of the piezoelectric member 12 is fixed to the fixing portion, the following may occur.

When the piezoelectric member 12 tries to expand, a side of the upper surface is more likely to expand than a side of the lower surface of the piezoelectric member 12, and flexural deformation occurs in the piezoelectric member 12. When flexural deformation occurs in the piezoelectric member 12, a distance between the first fixing portion 131 and the second fixing portion 132 becomes shorter than an original distance, and the transmission rate of vibration from the piezoelectric member 12 to the vibration portion 14 decreases. In order to solve the imbalance in elongation between the upper surface and the lower surface of the piezoelectric member 12, a configuration in which the fixing portion is fixed to the end surface of the piezoelectric member 12 is conceivable. However, considering that the piezoelectric member 12 is thin, when the fixing portion is fixed to the end surface, durability against impact is reduced, and this is not realistic.

On the other hand, as described in the present embodiment, if the piezoelectric member 12 is fixed to the fixing portion so as to be sandwiched between the upper and lower surfaces of the piezoelectric member 12, the elongation on the upper surface and the lower surface of the piezoelectric member 12 becomes equal, and the flexural deformation of the piezoelectric member is less likely to occur. Therefore, it is possible to avoid a decrease in the transmission rate of vibration from the piezoelectric member 12 to the vibration portion 14.

In each of the above embodiments, an example in which the vibration member 12 is rectangular in plan view has been described, but the vibration member 12 may be in a shape other than rectangular. In each of the above embodiments, an example in which the vibration portion 14 is rectangular in plan view has been described, but the vibration portion 14 may be in a shape other than rectangular. In each of the above embodiments, an example in which the number of the vibration portion support portions 15 connected to one vibration portion 14 is four has been described, but the number of the vibration portion support portions 15 may be other than four.

Note that some of the above-described embodiments may appropriately be combined and employed.

Note that the above-described embodiments disclosed this time are examples in all respects and are not restrictive. The scope of the present invention is indicated by the claims and includes all modifications within the meaning and scope equivalent to the claims.

### DESCRIPTION OF REFERENCE SYMBOLS

1: First plate member
2: Second plate member
10: Frame member
12: Piezoelectric member
12a, 12b, 12a1, 12a2, 12b1, 12b2: Conductive thin layer
12c: Piezoelectric material layer
14: Vibration portion
15: Vibration portion support portion
18: Constricted portion
30: Driving portion
31a, 31b, 31a1, 31a2, 31b1, 31b2, 31c: Wiring
40: Casing
41, 43: Spacer
43a: Frame member spacer
43b: Vibration portion spacer
42: Operation plate
89, 90, 91, 92, 93, 94, 95, 94a, 95a, 96, 96a, 97, 97a: Arrow
121: First end portion (of piezoelectric member)
122: Second end portion (of piezoelectric member)
125: First surface (of piezoelectric member)
126: Second surface (of piezoelectric member)
131: First fixing portion
132: Second fixing portion
161: First coupling portion
162: Second coupling portion
163: Third coupling portion
164: Fourth coupling portion
171: First connection member
172: Second connection member
301, 302, 303: Vibration structure
401, 402, 403: Vibration device
501, 502: Tactile sense presentation device
1311: First-surface first fixing portion
1312: Second-surface first fixing portion
1321: First-surface second fixing portion
1322: Second-surface second fixing portion
1611: First-surface first coupling portion
1612: Second-surface first coupling portion
1621: First-surface second coupling portion
1622: Second-surface second coupling portion
1631: First-surface third coupling portion
1632: Second-surface third coupling portion
1641: First-surface fourth coupling portion
1642: Second-surface fourth coupling portion

1. A vibration structure comprising:
a vibration portion;
a piezoelectric member having a first end portion and a second end portion respectively at positions opposite to each other, the piezoelectric member being arranged to be spaced apart from the vibration portion in a direction parallel to a surface of the vibration portion;
a frame member that surrounds both the vibration portion and the piezoelectric member, the frame member being spaced apart from both of the vibration portion and the piezoelectric member;
a vibration portion support portion that connects the vibration portion and the frame member;
a first fixing portion connected to the first end portion;
a second fixing portion connected to the second end portion;
a first coupling portion that connects the first fixing portion and the frame member;
a second coupling portion that connects the first fixing portion and the vibration portion;
a third coupling portion that connects the second fixing portion and the frame member; and
a fourth coupling portion that connects the second fixing portion and the vibration portion,
wherein when a combination of the first coupling portion and the second coupling portion is defined as a first connection member and a combination of the third coupling portion and the fourth coupling portion is a second connection member, each of the first connection member and the second connection member includes an elastically deformable portion having a locally increased ease of elastic deformation in a plane direction and a thickness direction.

2. The vibration structure according to claim 1, wherein the first coupling portion and the fourth coupling portion have a same structure.

3. The vibration structure according to claim 1, wherein
a first distance from the first fixing portion to the frame member is equal to a second distance from the second fixing portion to the frame member, and
a third distance from the first fixing portion to the vibration portion is equal to a fourth distance from the second fixing portion to the vibration portion.

4. The vibration structure according to claim 3, wherein
the first distance and the third distance are different, and
the second distance and the third distance are different.

5. The vibration structure according to claim 1, wherein the vibration portion support portion is in a V shape.

6. The vibration structure according to claim 1, wherein the vibration portion support portion is linear.

7. The vibration structure according to claim 1, wherein
the piezoelectric member has a first surface and a second surface opposite to each other,
the first fixing portion includes a first-surface first fixing portion connected to the first surface and a second-surface first fixing portion connected to the second surface,
the second fixing portion includes a first-surface second fixing portion connected to the first surface and a second-surface second fixing portion connected to the second surface,
the first coupling portion includes a first-surface first coupling portion that connects the first-surface first fixing portion and the frame member, and a second-surface first coupling portion that connects the second-surface first fixing portion and the frame member,
the second coupling portion includes a first-surface second coupling portion that connects the first-surface first fixing portion and the vibration portion, and a second-surface second coupling portion that connects the second-surface first fixing portion and the vibration portion,
the third coupling portion includes a first-surface third coupling portion that connects the first-surface second fixing portion and the frame member, and a second-surface third coupling portion that connects the second-surface second fixing portion and the frame member, and
the fourth coupling portion includes a first-surface fourth coupling portion that connects the first-surface second fixing portion and the vibration portion, and a second-surface fourth coupling portion that connects the second-surface second fixing portion and the vibration portion.

8. The vibration structure according to claim 2, wherein
the piezoelectric member has a first surface and a second surface opposite to each other,
the first fixing portion includes a first-surface first fixing portion connected to the first surface and a second-surface first fixing portion connected to the second surface,
the second fixing portion includes a first-surface second fixing portion connected to the first surface and a second-surface second fixing portion connected to the second surface,
the first coupling portion includes a first-surface first coupling portion that connects the first-surface first fixing portion and the frame member, and a second-surface first coupling portion that connects the second-surface first fixing portion and the frame member,
the second coupling portion includes a first-surface second coupling portion that connects the first-surface first fixing portion and the vibration portion, and a second-surface second coupling portion that connects the second-surface first fixing portion and the vibration portion,
the third coupling portion includes a first-surface third coupling portion that connects the first-surface second fixing portion and the frame member, and a second-surface third coupling portion that connects the second-surface second fixing portion and the frame member, and
the fourth coupling portion includes a first-surface fourth coupling portion that connects the first-surface second fixing portion and the vibration portion, and a second-surface fourth coupling portion that connects the second-surface second fixing portion and the vibration portion.

9. The vibration structure according to claim 1, wherein the elastically deformable portion includes a constricted portion at which a sectional area is locally small.

10. The vibration structure according to claim 1, wherein the elastically deformable portion includes a bent portion.

11. A vibration device comprising:
the vibration structure according to claim 1; and
a driving portion that drives the vibration structure with an AC voltage including two or more frequency components,
wherein the vibration structure has two or more resonance bands caused by a resonance mode in a direction parallel to a surface of the piezoelectric member, and each of the two or more resonance bands includes one of the two or more frequency components.

12. The vibration device according to claim 11, wherein the first coupling portion and the fourth coupling portion of the vibration structure have a same structure.

13. The vibration device according to claim 11, wherein
a first distance from the first fixing portion to the frame member is equal to a second distance from the second fixing portion to the frame member, and
a third distance from the first fixing portion to the vibration portion is equal to a fourth distance from the second fixing portion to the vibration portion.

14. The vibration device according to claim 13, wherein
the first distance and the third distance are different, and
the second distance and the third distance are different.

15. The vibration device according to claim 11, wherein
the piezoelectric member has a first surface and a second surface opposite to each other,
the first fixing portion includes a first-surface first fixing portion connected to the first surface and a second-surface first fixing portion connected to the second surface,
the second fixing portion includes a first-surface second fixing portion connected to the first surface and a second-surface second fixing portion connected to the second surface,
the first coupling portion includes a first-surface first coupling portion that connects the first-surface first fixing portion and the frame member, and a second-surface first coupling portion that connects the second-surface first fixing portion and the frame member,
the second coupling portion includes a first-surface second coupling portion that connects the first-surface first fixing portion and the vibration portion, and a second-surface second coupling portion that connects the second-surface first fixing portion and the vibration portion,
the third coupling portion includes a first-surface third coupling portion that connects the first-surface second fixing portion and the frame member, and a second-surface third coupling portion that connects the second-surface second fixing portion and the frame member, and
the fourth coupling portion includes a first-surface fourth coupling portion that connects the first-surface second fixing portion and the vibration portion, and a second-surface fourth coupling portion that connects the second-surface second fixing portion and the vibration portion.

16. The vibration device according to claim 11, wherein the elastically deformable portion includes a constricted portion at which a sectional area is locally small.

17. The vibration device according to claim 11, wherein the elastically deformable portion includes a bent portion.

18. A tactile sense presentation device comprising:
the vibration device according to claim 11; and
an operation plate connected to the vibration portion without being in contact with the piezoelectric member and the frame member.
